(19) United States
(12) Patent Application Publication
(10) Pub. No.: US 2015/0054783 A1
(43) Pub. Date: Feb. 26, 2015

(54) Touch Screen Stylus with Communication Interface

(71) Applicant: Microchip Technology Incorporated, Chandler, AZ (US)

(72) Inventor: Keith E. Curtis, Gilbert, AZ (US)

(21) Appl. No.: 14/464,012

(22) Filed: Aug. 20, 2014

Related U.S. Application Data
(60) Provisional application No. 61/868,708, filed on Aug. 22, 2013.

(51) Int. Cl. G06F 3/0354; G06F 3/044

(52) U.S. Cl. CPC G06F 3/03545; G06F 3/044
USPC 345/174

(57) ABSTRACT

A touch screen stylus has an electrode in its tip that is driven with a signal that provides graphical information to a touch screen device. When a user touches the touch screen with the tip of the stylus this graphical information is detected by a capacitive touch screen controller as a varying capacitance associated with the location where the stylus touches the touch screen. The signal may be turned on when pressure is applied at the tip of the stylus. Varying pressure on the tip of the stylus, tilt angle of the style and/or rotation of the stylus by the user may convey graphical line characteristic information. Input buttons and/or an input wheel on the stylus may be used to input commands or modify graphics on the touch screen. Feedback information may be transmitted back to the stylus by varying the scan rate of the touch screen controller.

### RELATED PATENT APPLICATION

This application claims priority to commonly owned U.S. Provisional Patent Application No. 61/868,708; filed Aug. 22, 2014, and is hereby incorporated by reference herein for all purposes.

### TECHNICAL FIELD

The present disclosure relates to a touch screen stylus used to input information on a touch screen device, in particular, a touch screen stylus having a communications interface with haptic feedback.

### BACKGROUND

Touch screens have become ubiquitous. A touch screen stylus allows a user to input data with a finger(s), in particular graphical data, check marks, signature, etc., or activate a user interface including buttons, sliders or other operative elements of a device's touch screen, e.g., tablet computer, etc. However most users are still not used to drawing with their fingers. Several brands of touch screen stylus have appeared on the market. Intelligent touch screen stylus communicates with touch screen devices through cable, sound, or Bluetooth® (Bluetooth® is a registered of Bluetooth SIG, Inc., a Delaware Corporation, located at 5209 Lake Washington Boulevard, Suite 350, Kirkland, Wash. 98033). Bluetooth® technology exists on touch screen tablets but has a high power requirement and is sensitive to radio frequency interference. An audio coupled stylus uses a microphone but also has a high power requirement and is sensitive to audio interference, e.g., loud talking and noise. IRDA is directional (line of sight) and not all touch screen tablets have an IRDA interface. A wired interface to the stylus is cumbersome.

### SUMMARY

Therefore a need exists for an improved touch screen stylus for touch screen applications, in particular, for simplified communication between the stylus, touch screen and the user with a software application in the touch screen device in which the stylus provides graphical input information and/or receives haptic feedback therefrom.

According to an embodiment, a capacitive touch screen stylus may comprise: a body; a tip at a proximate end of the body; an electrode integral with the tip and providing capacitive coupling to a touch screen; and a modulation unit coupled the electrode and may provide a modulated signal that may be detected by a capacitive touch screen controller coupled to the touch screen.

According to a further embodiment, the modulated signal may be selected from the group consisting of pulse width modulation (PWM), pulse position modulation (PPM), and pulse division modulation (PDM). According to a further embodiment, the modulated signal may be selected from the group consisting of on-off keying (OOK, amplitude-shift keying (ASK), phase-shift keying (PSK), and frequency-shift keying (FSK). According to a further embodiment, a plurality of pressure sensors may be provided at the proximate end of the body for measuring pressure forces applied to the tip. According to a further embodiment, the plurality of pressure sensors may measure how much force is being applied to the tip. According to a further embodiment, the plurality of pressure sensors may provide force information to determine an angle of the body to the touch screen. According to a further embodiment, the plurality of pressure sensors may provide force information to determine rotation of the body when touching the touch screen.

According to a further embodiment, at least one control button may be provided for inputting a command or modifying a portion of an image on the touch screen when pushed by a user. According to a further embodiment, at least one input wheel may be provided for inputting a command or modifying a portion of an image on the touch screen when rotated by a user. According to a further embodiment, According to a further embodiment, at least one haptic transducer may be provided According to a further embodiment, the at least one haptic transducer may be a vibration transducer for providing a vibration feedback to a user holding the stylus. According to a further embodiment, the at least one haptic transducer may be an audio transducer for providing audio feedback to a user holding the stylus.

According to a further embodiment, a digital processor and memory may be provided in the body, wherein the digital processor may be coupled to the modulation unit and send digital information to the capacitive touch screen controller via the touch screen. According to a further embodiment, a demodulation unit may be coupled to the electrode and the digital processor, wherein the demodulation unit may receive information from the capacitive touch screen controller via the touch screen. According to a further embodiment, the digital processor may receive information from the plurality of pressure sensors. According to a further embodiment, the digital processor may receive information from the at least one control button on the body. According to a further embodiment, the digital processor may receive information from the at least one input wheel on the body. According to a further embodiment, the digital processor may control the at least one haptic transducer. According to a further embodiment, the digital processor, memory and modulation unit may be provided by a microcontroller.

According to another embodiment, a touch screen and stylus system may comprise: a touch screen device that may comprise a capacitive touch screen, a capacitive touch screen controller coupled to the capacitive touch screen, and a digital processor and memory coupled to the capacitive touch screen controller; and a touch screen stylus that may comprise a body, a tip at a proximate end of the body, an electrode integral with the tip and providing capacitive coupling to the touch screen, and a modulation unit coupled the electrode and providing a modulated signal that may be detected by the capacitive touch screen controller coupled to the touch screen; wherein the touch screen stylus may provide graphical information to the touch screen device. According to a further embodiment, the graphical information may be selected from the group consisting of line width, line weight, and line color. According to a further embodiment, at least one control button may be provided on the body of the touch screen stylus for inputting a command or modifying a portion of an image on the touch screen when pushed by a user. According to a further embodiment, at least one input wheel may be provided on the body of the touch screen stylus for inputting a command or modifying a portion of an image on the touch screen when rotated by a user. According to a further embodiment, a plurality of pressure sensors may be located at the proximate end of the body of the touch screen stylus. According to a further embodiment, at least one haptic transducer may be provided in the body of the touch screen stylus.

According to yet another embodiment, a method for controlling a touch screen device with a touch screen stylus may comprise the step of sending graphical information from a touch screen stylus to a touch screen device through an electrode in a tip of the touch screen stylus proximate to a capacitive touch screen coupled to a capacitive touch screen controller in the touch screen device.

According to a further embodiment of the method, the graphical information may be selected from the group consisting of line width, line weight, and line color. According to a further embodiment of the method, may comprise the step of receiving feedback information from the touch screen device through the electrode in the tip of the touch screen stylus proximate to the capacitive touch screen coupled to the capacitive touch screen controller in the touch screen device. According to a further embodiment of the method, the feedback information may be selected from the group consisting of vibration and sound.

### BRIEF DESCRIPTION OF THE DRAWINGS

A more complete understanding of the present disclosure may be acquired by referring to the following description taken in conjunction with the accompanying drawings wherein:

FIG. 1 illustrates a schematic diagram of a stylus and touch screen device, according to a specific example embodiment of this disclosure; and

FIG. 2 illustrates a more detailed schematic block diagram of the stylus shown in FIG. 1.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

According to the teachings of this disclosure, a touch screen stylus may be designed to have a data interface, wherein the tip of the stylus may be driven with a modulated signal that provides, for example, color and line thickness information. A ground connection coupled to the tip of the stylus may be modulated with graphical line characteristic information, e.g., color and line thickness information that may be conveyed to a capacitive touch screen controller coupled to the touch screen. When the user touches the touch screen with the tip of the stylus this graphical line characteristic information may appear to the capacitive touch screen controller as a varying capacitance associated with the location where the stylus touches the touch screen. The modulated graphical line characteristic information signal may be turned on when pressure is applied at the tip of the stylus, e.g., tip of stylus touching the touch screen and turned off when the tip of the stylus is not touching the touch screen. Varying applied force, tilt angle, and/or rotation of the stylus by the user may be detected by the on board electronics in the stylus and may be transmitted to the touch screen to convey graphical line characteristic information.

A software application in the touch screen device may then demodulate the graphical line characteristic signal information from the stylus for correct rendering of the line being drawn thereon. Information may be transmitted back to the stylus by varying the scan rate of the touch screen. This information from the touch screen device may be detected by a comparator located in the stylus, demodulated and used by a microcontroller to control haptic devices. Examples may include providing haptic feedback effects through a vibration transducer and/or audio transducer in the stylus, e.g., simulation of the drag of a pencil on paper. Thus simplified communications between a stylus and a touch screen device may be provided through a low power communications channel using a transmit/receive electrode in the tip of the stylus and the touch screen capacitive structure.

Capacitive touch screen technology (mTouch®) is more fully explained at www.microchip.com in application notes: AN1250—Microchip CTMU for Capacitive Touch Applications; AN1325—mTouch® Metal Over Cap Technology; AN1334—Techniques for Robust Touch Sensing Design; AN1375—See What You Can Do with the CTMU; AN1478—mTouch® Sensing Solution Acquisition Methods Capacitive Voltage Divider; and AN1492—Microchip Capacitive Proximity Design Guide, wherein all of which are hereby incorporated by reference herein for all purposes. Haptic technology (GestIC®) is more fully explained at ww.microchip.com in product data sheets for the MTCH810 and MGC3130 devices, wherein all of which are hereby incorporated by reference herein for all purposes. GestIC® and mTouch® are registered trademarks of Microchip Technology Incorporated, Corporation Delaware, Legal Department, 2355 West Chandler Boulevard, Chandler, Ariz. 85224-6199.

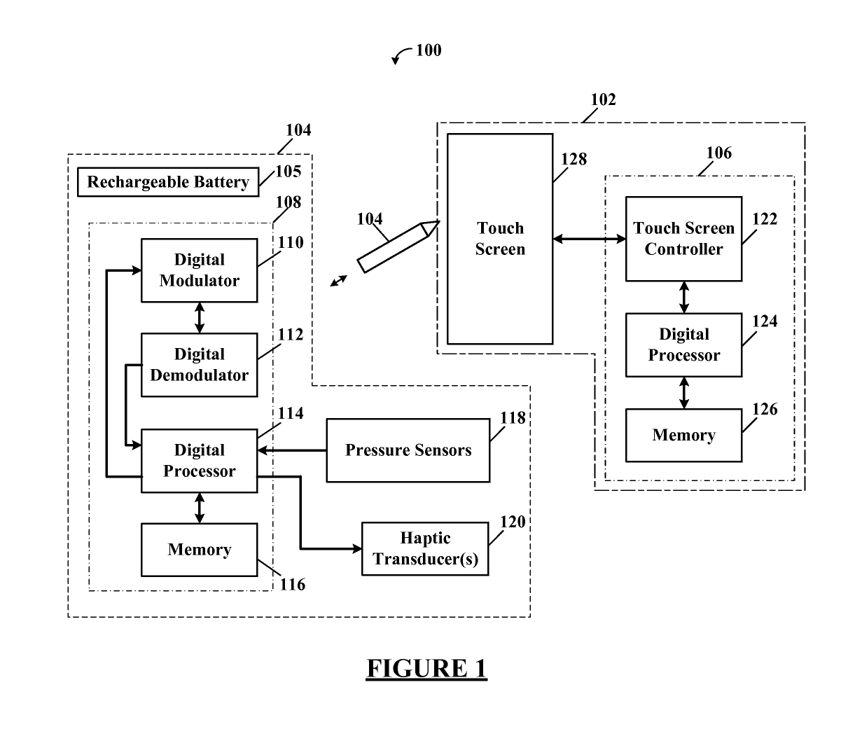

Referring to FIG. 1, depicted is a schematic diagram of a stylus and touch screen device, according to a specific example embodiment of this disclosure. A touch screen system, generally represented by the numeral 100, may comprise a touch screen device 102, e.g., computer tablet, smart phone, computer touch screen display; and a touch screen stylus 104 for actuating software buttons, drawing lines and cursively writing on the touch screen device 102. The touch screen device 102 may comprise a touch screen 128, a digital device 106 that may comprise a touch screen controller 122, a digital processor 124 and a memory 126. The digital device 106 may be a microcontroller or microprocessor of a personal computer, tablet, smart phone, etc. Touch screen scan detection may be performed using, but is not limited to, Microchip mTouch® technology.

The stylus 104 may comprise a battery 105, e.g., rechargeable battery, pressure, a plurality of pressure sensors 118, at least one haptic transducer 120, and a digital device 108 that may comprise a digital modulator 110, a digital demodulator 112, a digital processor 114 and memory 116 for the digital processor 114. The digital device 108 may be a microcontroller, a microprocessor, an application specific integrated circuit (ASIC), a programmable logic array (PLA) and the like.

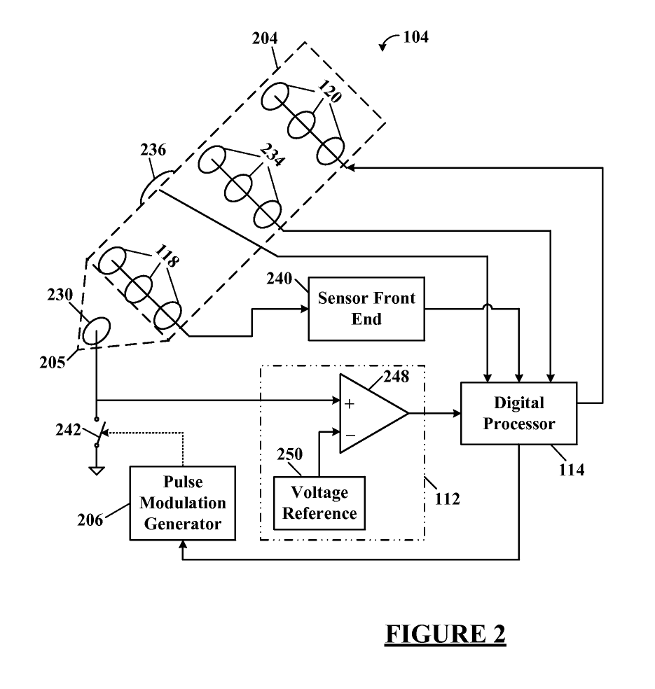

Referring to FIG. 2, depicted is a more detailed schematic block diagram of the stylus shown in FIG. 1. The stylus 104 may comprise a body 204 and a tip 205 located at a proximate end of the body 204. The stylus body 204 may enclose the battery 105, a plurality of pressure sensors 118, at least one haptic transducer 120, and the digital device 108. On the body 204, at least one control button 234 and/or at least one input wheel 236 may be provided for the user to modify or input information to the touch screen. The tip 205 of the stylus 104 may comprise an electrode 230 that may be grounded with a switch 242. The body 204 is conductive and is capacitively grounded through the user's hand, and the tip 205 is insulated so that electrode 230 remains ungrounded until the switch 242 is closed and pulls the electrode 230 to ground. When the electrode 230 in the tip 205 is grounded it will modify the capacitive value(s) of points on the touch screen 128 that the tip 205 is proximate to. These modified capacitance values may be detected by the touch screen controller 122 during scanning of the touch screen 128. The pulse modulation generator 206 may control the switch 242 at a modulation rate to convey information for the line characteristics to the touch screen controller 122. The switch 242 may be a solid state device.

The at least one haptic transducer 120 may be activated by the digital processor 114. Haptic information may be sent to the tip 205 (electrode 230) of the stylus 104 from the touch screen 128 by modulating the scan rate of touch screen controller 122. The electrode 230 may be used to receive this haptic information and the digital demodulator 112 may decode this haptic information and send it to the digital processor 114. The digital processor 114 may then activate the at least one of the haptic transducer 120, e.g., vibration and/or sound.

A plurality of pressure sensors 118 located at the proximate end of the body 204 may measure force vectors from the tip 205 when pressure is applied thereto, e.g., tip 205 touching the touch screen 128. For example, when the tip 205 is touched to and held perpendicular to the face of the touch screen 128 an axial depression of the tip 205 will provide to each of the pressure sensors 118 substantially the same force (pressure). When the body 204 of the stylus 104 is held at an angle less than 90 degrees to the face of the touch screen 128, different ones of the plurality of pressure sensors 118 will have different force (pressure) values applied respectively thereto. For example, an angular depression of the tip 205 held at 45 degrees to the face of the touch screen 128 will have approximately one-half the force applied in line with the center axis of the body 204 and one-half perpendicular to the center axis thereof. The ratio of these two forces may be decoded to determine the angle that the body 104 is being held to the face of the touch screen 128. Rotation of the stylus 104 about its axis may be determined by an angular depression of the tip 205 that may appear as a sinusoidal variation of forces (pressures) on the plurality of pressure sensors 118. Relative rotational directions may be determined by these side forces relative to an arbitrary 0 degree line parallel with the axis of the body 204.

Determination of the forces (pressures) on the plurality of pressure sensors 118, e.g., force applied from the tip 205 to the face of the touch screen 128, the angle of the body 204 relative to the face of the touch screen 128, and/or axial rotation of the body 204 may be used to convey line weight, color, and/or other characteristics of the lines and/or objects being drawn on the touch screen 128. In addition, for example, specific colors or line widths may be select by pushing a respective button 234 and/or by turning the select wheel 236 on the body.

The digital demodulator 112 may comprise a simple voltage comparator 248 and a voltage reference 250. A switch 242 may be used to ground the electrode 230 in the tip 205 when transmitting information from the stylus 104 to the touch screen controller 122 using, for example, a pulse modulation generator 206 (e.g., digital modulator 110). The pulse modulation generator 206 may be adapted to provide, for example but is not limited to, pulse width modulation (PWM), pulse position modulation (PPM), pulse division modulation (PDM), on-off keying (OOK) transmitting Manchester coded information, amplitude-shift keying (ASK), phase-shift keying (PSK), frequency-shift keying (FSK), and the like.

The aforementioned touch screen stylus with communications interface, according to the teachings of this disclosure, provides low power and secure communications between a touch screen stylus and a touch screen device. Furthermore, the proposed embodiments can use existing touch screen controllers and therefore compliments and expands the capabilities of touch screen technology.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. A capacitive touch screen stylus, comprising:
a body;
a tip at a proximate end of the body;
an electrode integral with the tip and providing capacitive coupling to a touch screen; and
a modulation unit coupled the electrode and providing a modulated signal that is detected by a capacitive touch screen controller coupled to the touch screen.

2. The capacitive touch screen stylus according to claim 1, wherein the modulated signal is selected from the group consisting of pulse width modulation (PWM), pulse position modulation (PPM), and pulse division modulation (PDM).

3. The capacitive touch screen stylus according to claim 1, wherein the modulated signal is selected from the group consisting of on-off keying (OOK, amplitude-shift keying (ASK), phase-shift keying (PSK), and frequency-shift keying (FSK).

4. The capacitive touch screen stylus according to claim 1, further comprising a plurality of pressure sensors at the proximate end of the body for measuring pressure forces applied to the tip.

5. The capacitive touch screen stylus according to claim 4, wherein the plurality of pressure sensors measures how much force is being applied to the tip.

6. The capacitive touch screen stylus according to claim 5, wherein the plurality of pressure sensors provides force information to determine an angle of the body to the touch screen.

7. The capacitive touch screen stylus according to claim 5, wherein the plurality of pressure sensors provides force information to determine rotation of the body when touching the touch screen.

8. The capacitive touch screen stylus according to claim 1, further comprising at least one control button for inputting a command or modifying a portion of an image on the touch screen when pushed by a user.

9. The capacitive touch screen stylus according to claim 1, further comprising at least one input wheel for inputting a command or modifying a portion of an image on the touch screen when rotated by a user.

10. The capacitive touch screen stylus according to claim 1, further comprising at least one haptic transducer.

11. The capacitive touch screen stylus according to claim 10, wherein the at least one haptic transducer is a vibration transducer for providing a vibration feedback to a user holding the stylus.

12. The capacitive touch screen stylus according to claim 10, wherein the at least one haptic transducer is an audio transducer for providing audio feedback to a user holding the stylus.

13. The capacitive touch screen stylus according to claim 1, further comprising a digital processor and memory in the body, wherein the digital processor is coupled to the modulation unit and sends digital information to the capacitive touch screen controller via the touch screen.

14. The capacitive touch screen stylus according to claim 13, further comprising a demodulation unit coupled to the electrode and the digital processor, wherein the demodulation unit receives information from the capacitive touch screen controller via the touch screen.

15. The capacitive touch screen stylus according to claim 13, wherein the digital processor receives information from the plurality of pressure sensors.

16. The capacitive touch screen stylus according to claim 13, wherein the digital processor receives information from the at least one control button on the body.

17. The capacitive touch screen stylus according to claim 13, wherein the digital processor receives information from the at least one input wheel on the body.

18. The capacitive touch screen stylus according to claim 13, wherein the digital processor controls the at least one haptic transducer.

19. The capacitive touch screen stylus according to claim 13, wherein the digital processor, memory and modulation unit are provided by a microcontroller.

20. A touch screen and stylus system, said system comprising:
a touch screen device comprising
a capacitive touch screen,
a capacitive touch screen controller coupled to the capacitive touch screen, and
a digital processor and memory coupled to the capacitive touch screen controller; and
a touch screen stylus comprising
a body,
a tip at a proximate end of the body,
an electrode integral with the tip and providing capacitive coupling to the touch screen, and
a modulation unit coupled the electrode and providing a modulated signal that is detected by the capacitive touch screen controller coupled to the touch screen;
wherein the touch screen stylus provides graphical information to the touch screen device.

21. The touch screen and stylus system according to claim 20, wherein the graphical information is selected from the group consisting of line width, line weight, and line color.

22. The touch screen and stylus system according to claim 20, further comprising at least one control button on the body of the touch screen stylus for inputting a command or modifying a portion of an image on the touch screen when pushed by a user.

23. The touch screen and stylus system according to claim 20, further comprising at least one input wheel on the body of the touch screen stylus for inputting a command or modifying a portion of an image on the touch screen when rotated by a user.

24. The touch screen and stylus system according to claim 20, further comprising a plurality of pressure sensors located at the proximate end of the body of the touch screen stylus.

25. The touch screen and stylus system according to claim 20, further comprising at least one haptic transducer in the body of the touch screen stylus.

26. A method for controlling a touch screen device with a touch screen stylus, said method comprising the step of:
sending graphical information from a touch screen stylus to a touch screen device through an electrode in a tip of the touch screen stylus proximate to a capacitive touch screen coupled to a capacitive touch screen controller in the touch screen device.

27. The method according to claim 26, wherein the graphical information is selected from the group consisting of line width, line weight, and line color.

28. The method according to claim 26, further comprising the step of receiving feedback information from the touch screen device through the electrode in the tip of the touch screen stylus proximate to the capacitive touch screen coupled to the capacitive touch screen controller in the touch screen device.

29. The method according to claim 28, wherein the feedback information is selected from the group consisting of vibration and sound.
